(19) United States
(12) Patent Application Publication
(10) Pub. No.: US 2025/0276544 A1
(43) Pub. Date: Sep. 4, 2025

(54) WHEEL COVER WITH CUSTOMIZABLE BUTTON CAP

(71) Applicant: Ford Global Technologies, LLC, Dearborn, MI (US)

(72) Inventors: Stuart C. Salter, White Lake, MI (US); Jeff Robert Seaman, Petersburg, MI (US); Diego Teutli, Mexico City (MX); Erick Juan Bautista, Mexico City (MX); Ricardo Ramirez, La Paz (MX); Steve Denby, Dearborn, MI (US)

(21) Appl. No.: 18/591,361

(22) Filed: Feb. 29, 2024

(51) Int. Cl. B60B 7/00; B60B 7/04; B60B 7/08; B60B 7/12

(52) U.S. Cl. CPC B60B 7/0053; B60B 7/006; B60B 7/04; B60B 7/08; B60B 7/12; B60B 2900/321; B60B 2900/572

(57) ABSTRACT

A wheel cover for a wheel of a vehicle may include a cover portion removably operably coupleable to the wheel via a first set of retention tabs, the cover portion may be centered at an axis of rotation of the wheel and may cover spokes of the wheel, and a button cap removably operably coupleable to the wheel cover via a second set of retention tabs, the button cap may be centered at the axis of rotation of the wheel. The first set of retention tabs may be urged by a wire ring into engagement with a lip of the wheel, the lip may extend around the axis of rotation at a center bore of the wheel. The second set of retention tabs may insert into corresponding ones of a set of retention slots disposed in the cover portion.

### TECHNICAL FIELD

Example embodiments generally relate to wheel covers and, more particularly, relate to a button cap for a wheel cover assembly.

### BACKGROUND

Many modern vehicles, including battery electric vehicles (BEV), hybrid electric vehicles (HEV), and internal combustion engine vehicles (ICE), may wish to maximize efficiency and thus achieve a maximum possible operating range. To accomplish this goal, vehicles are being produced including increasingly lighter weight components, and more aerodynamic components, to reduce weight and drag coefficient of the vehicle. One example of a common component used among modern vehicles may be alloy wheels due to their relatively low weight and high durability compared to other types of wheels. To add to the aerodynamic performance of the alloy wheels, and thus reduce their drag coefficient, many vehicles may include the option of having wheel covers disposed on the wheels to provide a more aerodynamic design that generates less drag and increases the overall efficiency and operating range of the vehicle.

The wheel covers may sometimes attach to the wheel via a hub secure, and may also include a button cap often glued or snapped onto the wheel cover, which in many cases may rarely be removed or changed out for a different button cap. Due to the wheel covers being designed primarily to reduce drag, drivers of the vehicle may desire to change out or remove the wheel covers depending on the use case of the vehicle to balance looks with aerodynamic performance. In such cases, the button cap may provide drivers with a simple way to customize the vehicle on their own. Thus, rather than produce different button caps for different driving scenarios, there may be a desire to create a button cap that may be used with multiple different wheel covers and/or with the wheels without wheel covers.

### BRIEF SUMMARY OF SOME EXAMPLES

In accordance with an example embodiment, a wheel cover for a wheel of a vehicle of an example embodiment may be provided. The wheel cover may include a cover portion removably operably coupleable to the wheel via a first set of retention tabs, the cover portion may be centered at an axis of rotation of the wheel and may cover spokes of the wheel, and a button cap removably operably coupleable to the wheel cover via a second set of retention tabs, the button cap may be centered at the axis of rotation of the wheel. The first set of retention tabs may be urged by a wire ring into engagement with a lip of the wheel, the lip may extend around the axis of rotation at a center bore of the wheel. The second set of retention tabs may insert into corresponding ones of a set of retention slots disposed in the cover portion.

In another example embodiment, a wheel assembly for a vehicle may therefore be provided. The wheel assembly may include a wheel which may be operably coupled to the vehicle, the wheel may include a lip that may extend around an axis of rotation at a center bore of the wheel, a wheel cover that may be removably operably coupleable to the lip via a first set of retention tabs, the wheel cover may be centered at the axis of rotation of the wheel to cover spokes of the wheel, and a button cap that may be removably operably coupleable to the wheel cover via a second set of retention tabs, the button cap may be centered at the axis of rotation of the wheel. The first set of retention tabs may be urged by a wire ring into engagement with the lip. The second set of retention tabs may insert into corresponding ones of a set of retention slots disposed in the wheel cover.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 illustrates a block diagram of a wheel assembly in accordance with an example embodiment;

FIG. 2 depicts a perspective view of the wheel assembly in accordance with an example embodiment;

FIG. 3 depicts an explodes perspective view of the wheel assembly in accordance with an example embodiment;

FIG. 4 illustrates a perspective view of the interior surface of the cover portion in accordance with an example embodiment;

FIG. 5 illustrates a close up perspective view of the first set of retention tabs taken from box 5 in FIG. 4 in accordance with an example embodiment;

FIG. 6 illustrates a close up perspective view of the button cap and the recessed portion in accordance with an example embodiment;

FIG. 7 illustrates a top view of the wheel cover with the button cap removed in accordance with an example embodiment;

FIG. 8 illustrates a close up top view of the recessed portion taken from box 8 in FIG. 7 in accordance with an example embodiment;

FIG. 9 illustrates an isolated top side perspective view of the button cap in accordance with an example embodiment;

FIG. 10 illustrates an isolated bottom side perspective view of the button cap in accordance with an example embodiment;

FIG. 11 illustrates a section view of the wheel assembly in accordance with an example embodiment;

FIG. 12 illustrates a section view of the button cap operably coupled to the wheel cover in accordance with an example embodiment;

FIG. 13 illustrates a section view of the button cap operably coupled to the wheel without the wheel cover in accordance with an example embodiment; and

FIG. 14 illustrates a perspective view of the button cap operably coupled to the wheel without the wheel cover in accordance with an example embodiment.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable requirements. Like reference numerals refer to like elements throughout. Furthermore, as used herein, the term “or” is to be interpreted as a logical operator that results in true whenever one or more of its operands are true. As used herein, operable coupling should be understood to relate to direct or indirect connection that, in either case, enables functional interconnection of components that are operably coupled to each other.

Some example embodiments described herein may address the problems described above. In this regard, for example, some embodiments may provide a wheel cover for a wheel of a vehicle that may include a customizable button cap. The button cap of some embodiments may be interchangeably operably coupled to the wheel cover and to the wheel alone without the wheel cover. Thus the wheel and the wheel cover may be customized by changing out the button cap or changing out a graphic disposed inside of the button cap. Additionally, the wheel cover and the button cap may be more robustly operably coupled to the wheel, and thus the wheel cover and button cap may be less likely to be inadvertently removed from the wheel.

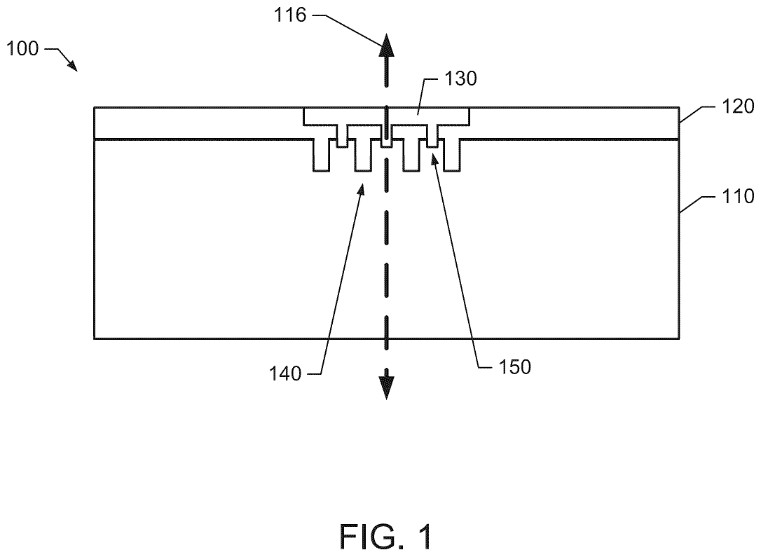

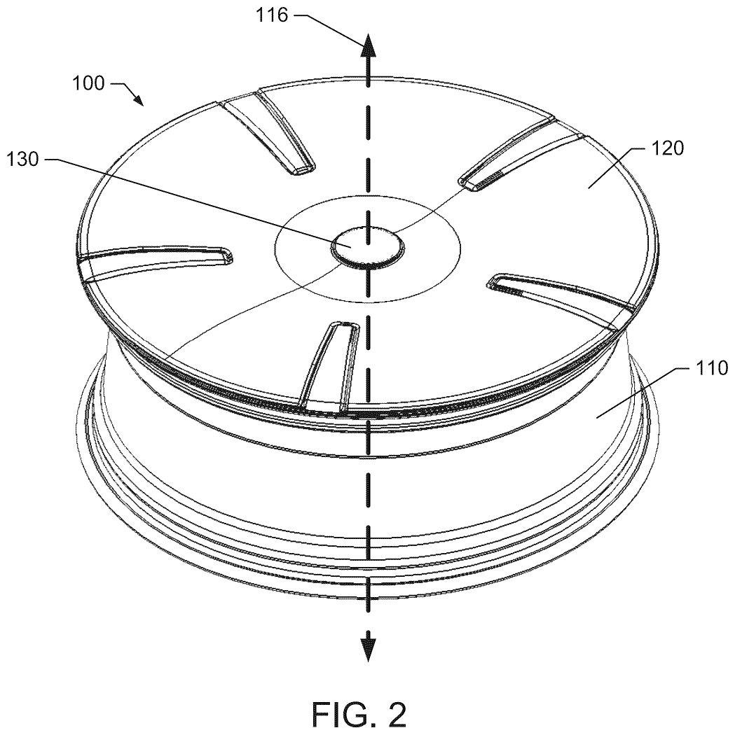

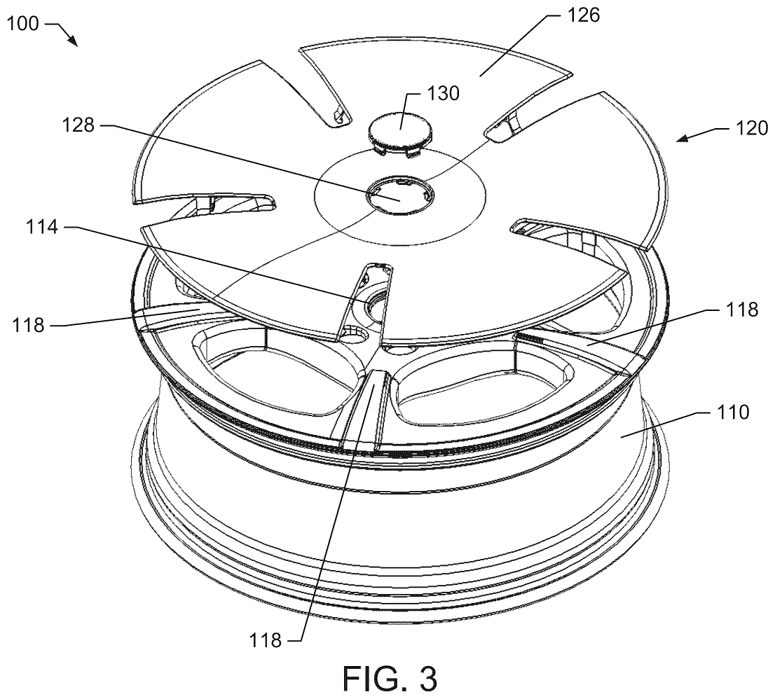

FIG. 1 illustrates a block diagram of a wheel assembly 100 for a vehicle according to an example embodiment, FIG. 2 depicts a perspective view of the wheel assembly 100 of an example embodiment, and FIG. 3 depicts an exploded view of the wheel assembly 100 in accordance with an example embodiment. Referring now to FIGS. 1-3, the wheel assembly 100 may include a wheel 110, a wheel cover 120 and a button cap 130. The wheel 110 may be operably coupled to the vehicle via a wheel hub (not shown) disposed at the vehicle. The wheel hub may be operably coupled to the wheel 110 at a center bore 114 of the wheel 110, which may be a circular orifice that may include an axis of rotation 116 extending perpendicularly through the center. The wheel 110 may also include a lip 112 that may extend around the center bore 114 of the wheel 110. The lip 112 may also extend around the axis of rotation 116 of the wheel 110, which may also extend through the center of the wheel cover 120 and the button cap 130.

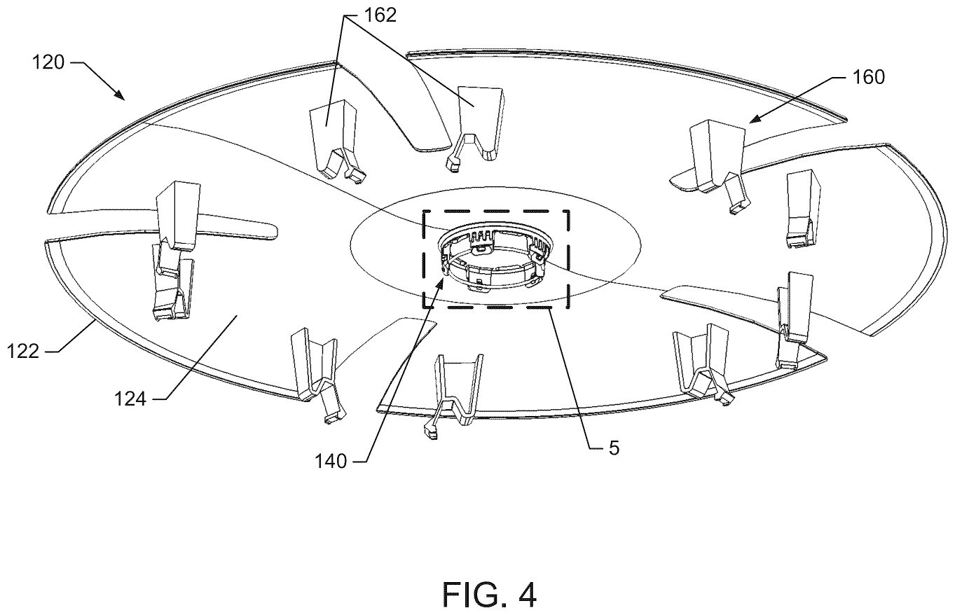

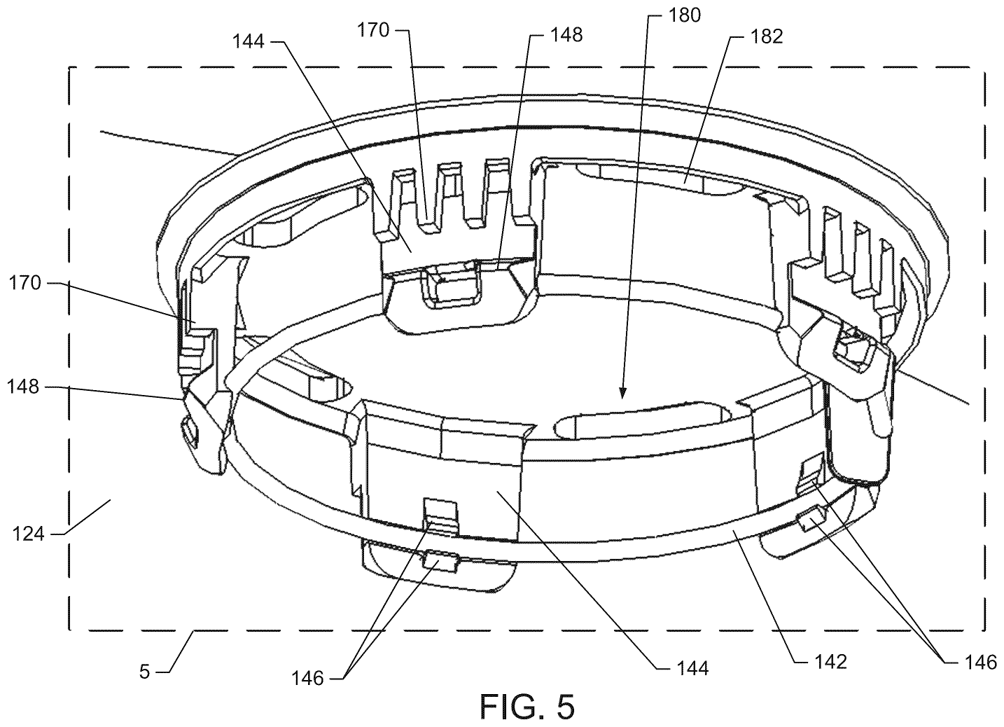

In some cases, the lip 112 may be disposed radially inward of spokes 118 of the wheel 110, which may extend from the center bore 114 out towards a perimeter of the wheel 110. The wheel cover 120 may be centered at the axis of rotation 116 to cover an outer face of the wheel 110 while the wheel cover 120 may be operably coupled to the wheel 110. The wheel cover 120 may be removably operably coupleable to the wheel 110 via a first set of retention tabs 140 and a set of clips 160. The first set of retention tabs 140 and the set of clips 160 will be discussed in more detail below in reference to FIGS. 4 and 5. The button cap 130 may be removably operably coupleable to the wheel cover 120 via a second set of retention tabs 150 in a position such that the button cap 130 may be centered at the axis of rotation 116 of the wheel 110. The wheel cover 120 of some example embodiments may include a cover portion 122, and the cover portion 122 may include an interior surface 124 that may face inwardly toward the wheel 110 and an exterior surface 126 that may face outwardly away from the wheel 110 when the wheel cover 120 may be operably coupled to the wheel 110. The cover portion 122 may provide aerodynamic design enhancements to the wheel 110 (i.e. a reduced drag coefficient of the wheel 110) by covering the spokes 118 and redirecting airflow to flow by the wheel 110 smoother when the vehicle is driven. The first set of retention tabs 140 may therefore operably couple the wheel cover 120 to an outer face of the wheel 110 such that the spokes 118 may be covered by the cover portion 122, as shown in FIG. 2.

FIG. 4 depicts a perspective view of the interior surface 124 of the wheel cover 120 according to an example embodiment, and FIG. 5 illustrates a close up perspective view of the first set of retention tabs 140 taken from box 5 in FIG. 4. In some cases, the first set of retention tabs 140 may include a wire ring 142 which may urge the first set of retention tabs 140 into engagement with the lip 112 to removably operably couple the wheel cover 120 to the wheel 110. In some cases, the wheel cover 120 may be formed from a plastic material, a polymer material, a composite material, or any combination thereof, perhaps through an injection molding process. As such, the first set of retention tabs 140 may be formed from the same material as the cover portion 122, and perhaps formed during the same process as the cover portion 122 as well. The first set of retention tabs 140 may be arranged in a circle pattern so that individual ones of the first tabs 144 in the first set of retention tabs 140 may operably couple to a different portion of the lip 112. In this regard, the first tabs 144 may therefore be radially disposed and equidistantly spaced apart from one another. This may allow the first set of retention tabs 140 to evenly distribute forces generated while the cover portion 122 may be operably coupled to the wheel 110 amongst the individual first tabs 144 that make up the first set of retention tabs 140. In an example embodiment, the first set of retention tabs 140 may include five individual first tabs 144. In some other cases, more or less may be used depending on the size of the wheel 110.

Also shown in FIG. 4, the set of clips 160 may include a plurality of individual clips 162 that may operably couple the cover portion 122 to the spokes 118 of the wheel 110. In this regard, the set of clips 160 may be disposed radially outward of the first set of retention tabs 140 on the interior surface 124 of the cover portion 122. In some cases, the clips 162 may be disposed in pairs, and each pair of clips 162 may operably couple to a single spoke 118 of the wheel 110. In this regard, in each pair of clips 162, one clip 162 may operably couple to a first side of the spoke 118 and the other clip 162 in the pair may operably couple to a second side of the spoke 118. As such, each spoke 118 may be operably coupled to a clip 162 on each side of the spoke 118, and the set of clips 160 may therefore provide additional support for the wheel cover 120 relative to the wheel 110. In other words, the set of clips 160 may prevent the cover portion 122 from rattling against the spokes 118 and creating noises and vibrations. Thus, together, the first set of retention tabs 140 and the set of clips 160 may operably couple the wheel cover 120 to the wheel 110.

As seen in FIG. 5, the wire ring 142 may be formed from a metallic material disposed in a C shape to provide a biasing force to the first tabs 144. In this regard, the wire ring 142 may be disposed on a radially interior side of the first set of retention tabs 140 and may urge each first tab 144 radially outward and into engagement with the lip 112. In an example embodiment, each first tab 144 may include a wire holder 146 disposed on a radially interior surface of each first tab 144. The wire holder 146 may operably couple the wire ring 142 to each first tab 144 so that the wire ring 142 may not move out of position relative to the first set of retention tabs 140. In some cases, the wire ring 142 may operably couple to each wire holder 146 via a snap fit. In an example embodiment, the wire ring 142 may not be a complete closed circle ring shape. In other words, the wire ring 142 may instead be a C shaped member. Functionally similar to an internal C-clip or retaining ring, the wire ring 142 may provide a biasing force that may “open” the C shape wider. This force may urge the first tabs 144 radially outward to engage the first tabs 144 with the lip 112, but simultaneously, this force may also help hold the wire ring 142 in the wire holder 146 as well. In an example embodiment, the wire holder 146 may include upper and lower anchors that may operably couple to the wire ring 142 via the snap fit. In this regard, the wire ring 142 may snap into the wire holder 146 in between the upper and lower anchors.

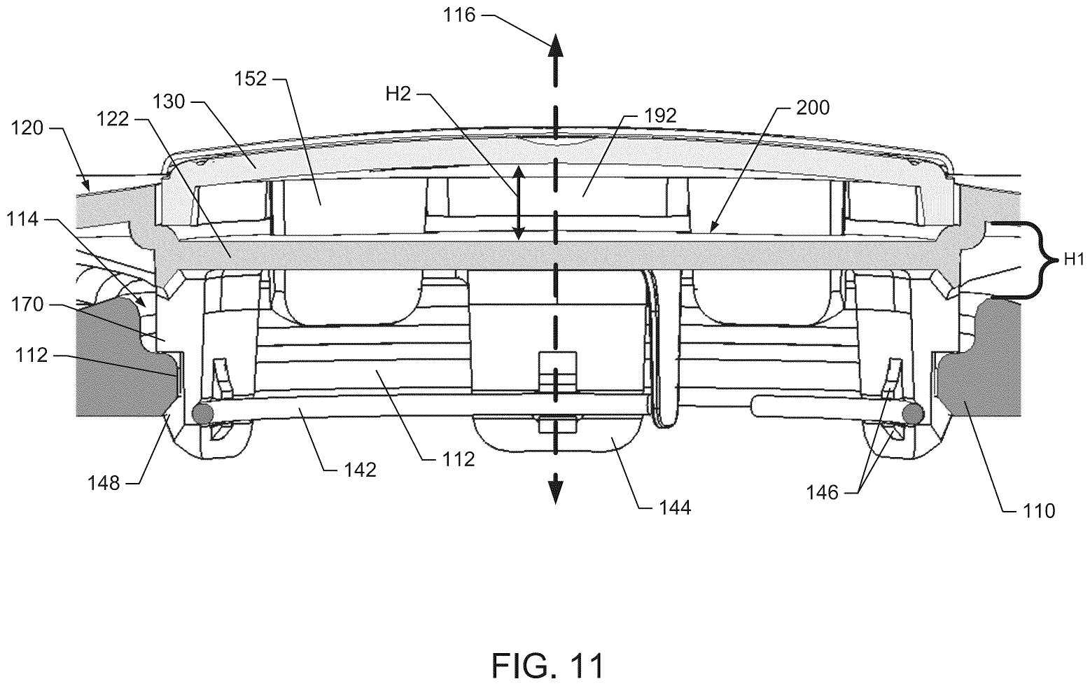

The first set of retention tabs 140 may also include a first projection 148 and a first set of spacer members 170 disposed on a radially exterior side of each first tab 144 of the first set of retention tabs 140. In this regard, the radially exterior side of each first tab 144 may be disposed opposite from the radially interior side of each first tab 144. For example, the radially interior side of the first tab 144 may face inwardly with respect to the circular orientation of the first set of retention tabs 140, the radially exterior side of the first tab 144 may face outwardly with respect to the circular orientation of the first set of retention tabs 140. The first projection 148 may be disposed at a distal end of each first tab 144, away from where the first tab 144 operably couples to the cover portion 122. In some cases, as the wheel cover 120 is operably coupled to the wheel 110, each instance of the first projection 148 may operably couple its respective first tab 144 to the lip 112 by first sliding beyond the lip 112 and then engaging a back side of the lip 112 by snapping in place due to the bias force provided by the wire ring 142. In this regard, the first projection 148 may be disposed at the back side of the lip 112 while the wheel cover 120 may be operably coupled to the wheel 110. On the other hand, the first set of spacer members 170 may be disposed closer to the cover portion 122 on the first tabs 144, and spaced apart from the first projection 148. The first set of spacer members 170 may be disposed at a front side of the lip 112 while the wheel cover 120 may be operably coupled to the wheel 110 such that the lip 112 may be disposed between the first projection 148 and the first set of spacer members 170. In some cases, the first set of spacer members 170 may define a first standoff height (H1) between the wheel cover 120 and the wheel 110. The engagement of each first tab 144 with the lip 112 will be described in further detail below in reference to FIG. 11.

Also seen in FIG. 5, the cover portion 122 may include a set of retention slots 180. The set of retention slots 180 may include individual retention slots 182 that may be disposed in a circular pattern, similar to the first set of retention tabs 140. Each retention slot 182 in the set of retention slots 180 may define an opening extending entirely through the cover portion 122. Each slot 182 may be substantially elliptical in shape and may be arcuate as well. In this regard, the set of retention slots 180 may be disposed in a circular pattern around the perimeter of a recessed portion 128 at the center of the wheel cover 120. In some cases, each slot 182 of the set of retention slots 180 may be disposed between consecutive first tabs 144 of the first set of retention tabs 140. Thus, at the interior surface 124 of the cover portion 122, the first tabs 144 and the slots 182 may alternate in the circular pattern. In other words, each first tab 144 may be disposed between two slots 182 and each slot 182 may be disposed between two first tabs 144. In an example embodiment, the set of retention slots 180 may include five individual slots 182. In some other cases, more or less may be used depending on the size of the wheel 110.

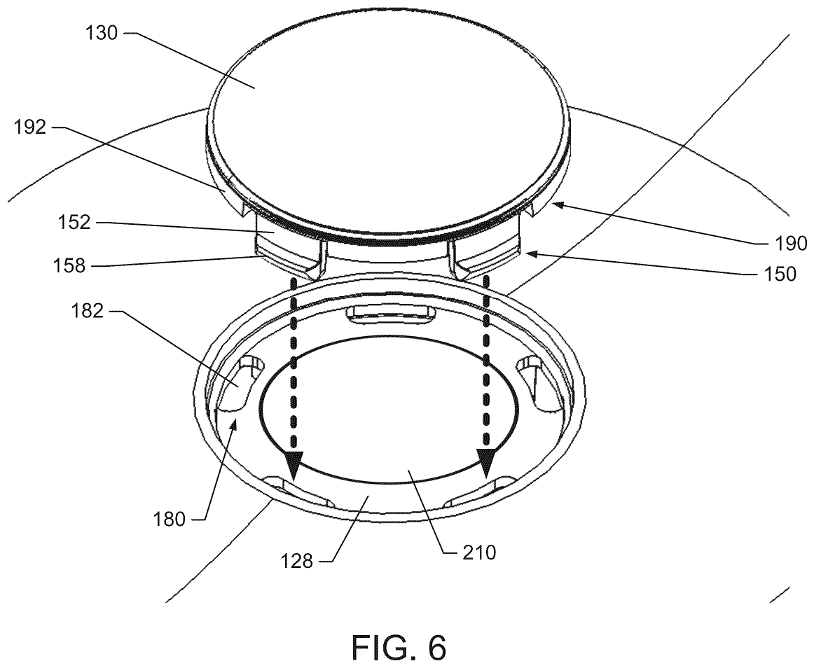

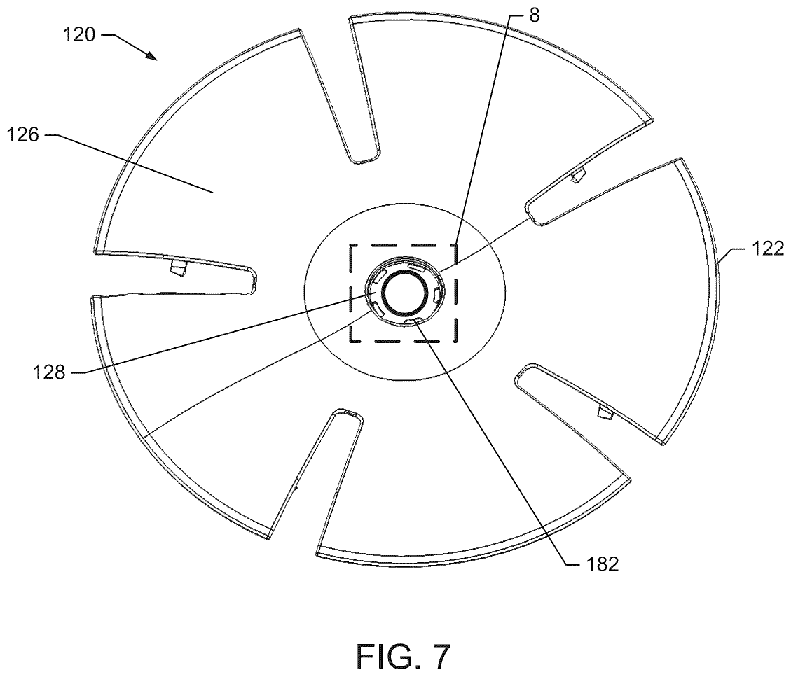

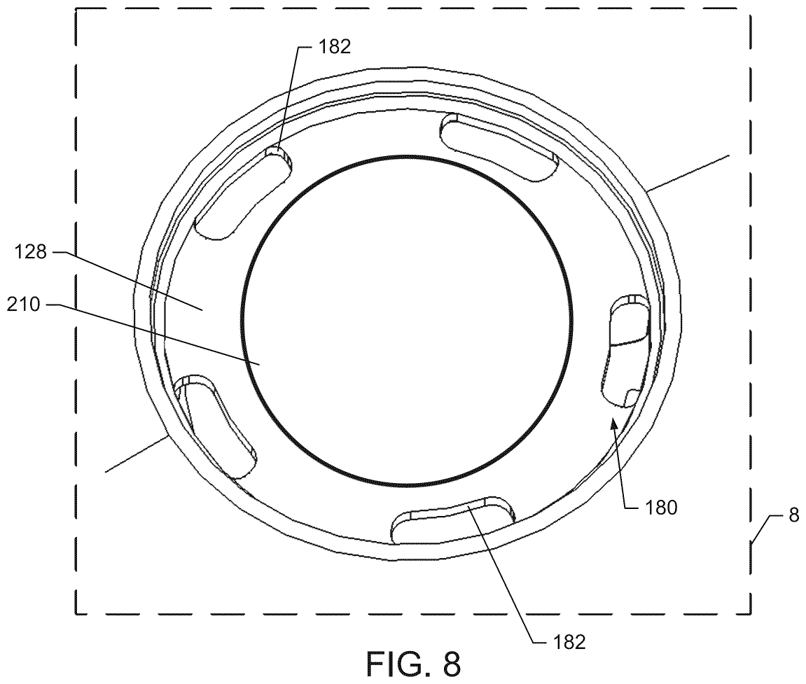

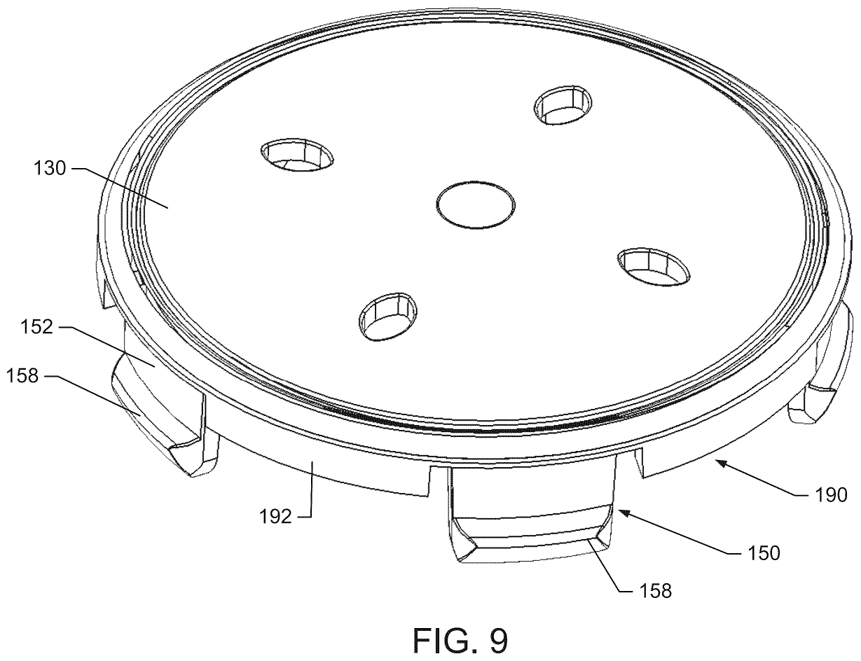

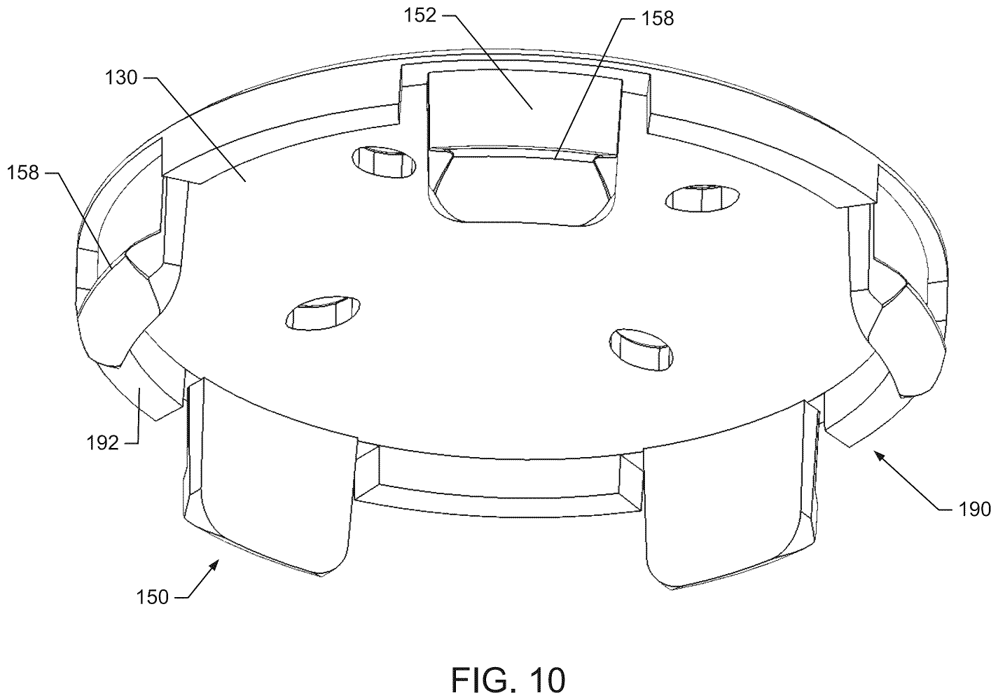

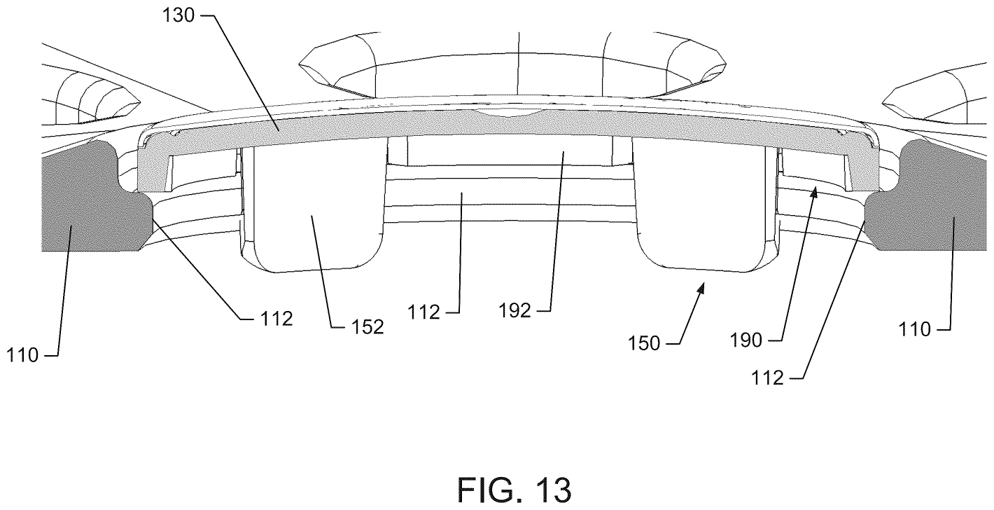

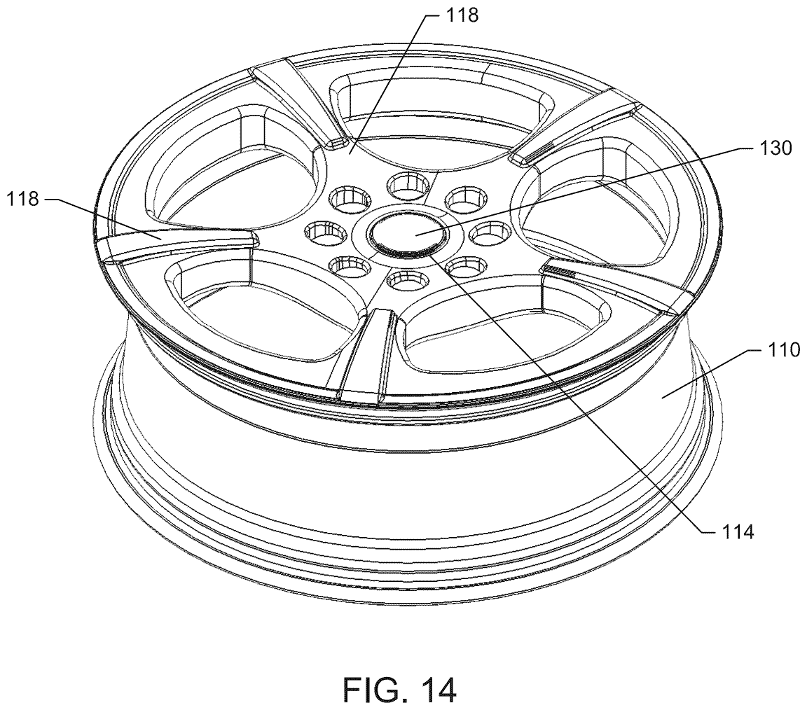

FIG. 6 depicts the button cap 130 operably coupling to the recessed portion 128 of the wheel cover 120 according to an example embodiment. FIG. 7 illustrates a top perspective view of the wheel cover 120 showing the exterior surface 126 and the set of retention slots 180 in accordance with an example embodiment. FIG. 8 shows a close up top perspective view of the recessed portion 128 including the set of retention slots 180 taken from box 8 in FIG. 7. FIGS. 9 and 10 show top and bottom perspective views of the button cap 130 according to an example embodiment. Referring now to FIGS. 6-10, in some cases, individual second tabs 152 of the second set of retention tabs 150 may insert into corresponding slots 182 of the set of retention slots 180 to removably operably couple the button cap 130 to the wheel cover 120. However, in other cases, the button cap 130 may be alternately operably coupleable to the wheel 110 without the wheel cover 120 and to the wheel cover 120 itself. In this regard, the wheel cover 120 may be removed from the wheel 110, and the button cap 130 may be operably coupleable to the wheel 110 via the lip 112, excluding the wheel cover 120. This will be discussed in further detail later in reference to FIGS. 13 and 14.

The button cap 130 may operably couple to the wheel cover 120 via the second set of retention tabs 150 inserting into the set of retention slots 180 and operably coupling thereto via a snap fit. In this regard, each second tab 152 of the second set of retention tabs 150 may include a second projection 158. Each second projection 158 may pass through a respective retention slot 182 as the button cap 130 is inserted into the recessed portion 128. The second projections 158 snap into place responsive to passing through the slot 182 to operably couple the button cap 130 to the wheel cover 120. In such cases, the second tabs 152 of the second set of retention tabs 150 may engage the interior surface 124 of the cover portion 122 to hold the button cap 130 in place in the recessed portion 128. The second set of retention tabs 150 may be arranged in a circle shape so that individual ones of the second tabs 152 in the second set of retention tabs 150 may operably couple to respective different slots 182 of the set of retention slots 180. In this regard, the second tabs 152 may be radially disposed and equidistantly spaced apart from one another. This may allow the second set of retention tabs 150 to evenly distribute forces generated while the cover portion 122 may be operably coupled to the wheel 110 amongst the individual second tabs 152 that make up the second set of retention tabs 150. In an example embodiment, the second set of retention tabs 150 may include five individual second tabs 152. In some other cases, more or less may be used depending on the size of the wheel 110.

Due to their snap fit operable coupling, the second tabs 152 may bend radially in and radially out responsive to the second projection 158 passing through the slot 182. Over time, due to this repeated bending of the second tabs 152, the second tabs 152 may experience material fatigue that may reduce the longevity of the second set of retention tabs 150 due to repeatedly inserting and removing the button cap 130 numerous times over its lifespan. In order to increase the resistance of the second tabs 152 to material fatigue, and increase the longevity of the second tabs 152, the second tabs 152 may be formed through a dual shot molding process (also known as two shot injection molding, double shot injection molding, multi shot injection molding, etc.). Dual shot molding may allow two different materials to be included in a same injection molded component so that the component may exhibit desired characteristics of both materials. For example, the second tabs 152 may be dual shot molded to include a more flexible material disposed where the second tabs 152 meet the body of the button cap 130, and to include a harder material disposed at the distal end of the second tabs 152 where the second projection 158 may be disposed and where the second tabs 152 may engage the wheel cover 120. In this regard, the more flexible material may permit the second tabs 152 to repeatedly bend with greater ease as the second projection 158 passes through the slot 182, and the harder material may hold up better to engaging and disengaging with the wheel cover 120, or with the lip 112, repeatedly over time. As compared to the harder material, the more flexible material may last for many more cycles of the second tabs 152 being bent, which may increase the longevity of the second set of retention tabs 150.

In some cases, the button cap 130 may include a second set of spacer members 190 that may define a second standoff height (H2) between the button cap 130 and the wheel cover 120. In an example embodiment, individual second spacer members 192 of the second set of spacer members 190 may be disposed between consecutive second tabs 152 of the second set of retention tabs 150. The second spacer members 192 may contact the exterior surface 126 of the cover portion 122 responsive to the second set of retention tabs 150 being inserted into the set of retention slots 180. In some other cases, the second spacer members 192 may contact the lip 112 of the wheel 110 responsive to the button cap 130 being inserted into the center bore 114. In an example embodiment, the first standoff height (H1) may be approximately equal to the second standoff height (H2). This may facilitate the button cap 130 operably coupling to the wheel cover 120 or directly operably coupling to the wheel 110 by ensuring that the second set of retention tabs 150 may engage either the lip 112 or the set of retention slots 180 at the same standoff height. In some cases, each second spacer member 192 of the second set of spacer members 190 may be disposed between consecutive second tabs 152 of the second set of retention tabs 150. Thus, at an inside face of the button cap 130, the second tabs 152 and the second spacer members 192 may alternate in a circular pattern around the perimeter of the button cap 130. In other words, each second tab 152 may be disposed between two second spacer members 192 and each second spacer member 192 may be disposed between two second tabs 152.

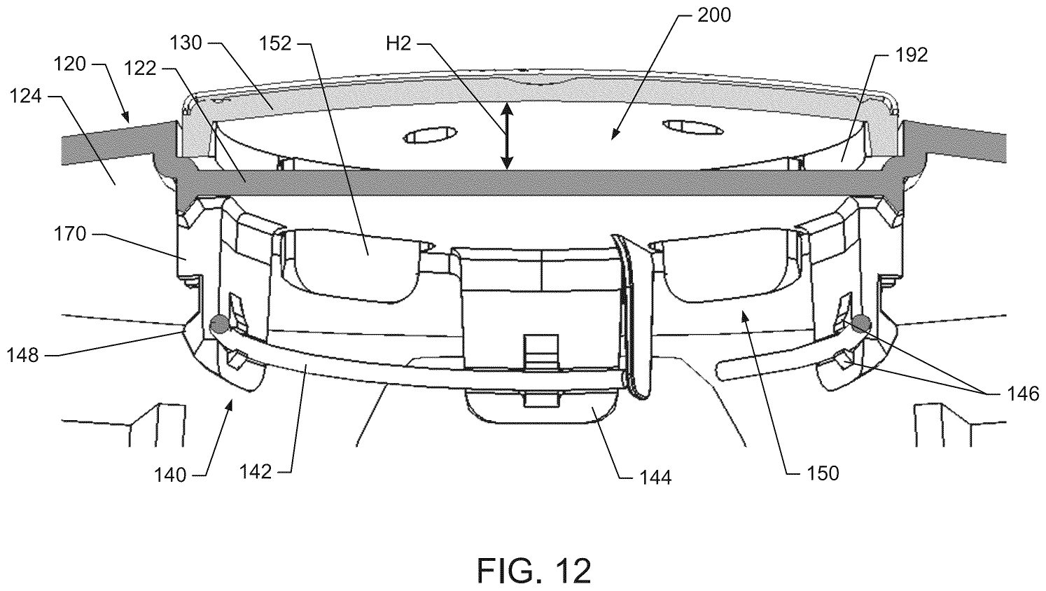

FIG. 11 depicts a section view of the wheel assembly 100 including the wheel 110, the wheel cover 120, and the button cap 130 according to an example embodiment. FIG. 12 illustrates a section view of the wheel cover 120 and the button cap, with the wheel 110 removed for visibility, in accordance with an example embodiment. FIG. 13 illustrates a section view of the button cap 130 and the wheel 110 of an example embodiment. Referring now to FIGS. 11-13, the second standoff height (H2) may define a customization cavity 200 disposed between the button cap 130 and the wheel cover 120 in the recessed portion 128 of the cover portion 122. The customization cavity 200 may be bound by the cover portion 122 and the button cap 130, and may be customizable with a graphic 210. In this regard, in some cases the button cap 130 may be formed from a translucent material that may allow light to pass through the button cap 130 and into the customization cavity 200, and thus onto the graphic 210 (which may be better shown in FIGS. 6-8). For example, the button cap 130 may be formed from a clear acrylic material, or any other similarly translucent material. In some cases, the graphic 210 may be a sticker having an emblem, logo, name, personal identifier, family crest, or any other visual marker as desired by the driver. In an example embodiment, the driver may create their own graphic 210 to display in the customization cavity 200. In some cases, the driver may be able to purchase the graphic 210 that they wish to display in the customization cavity 200. In an example embodiment, the second standoff height (H2) may be greater than the first standoff height (H1) to create a 3D effect with the graphic 210 within the customization cavity 200. In such cases, the driver may be able to 3D print the graphic 210 and adhere it to the cover portion 122 due to the increased second standoff height (H2) providing more space in the customization cavity 200.

In some other cases, the graphic 210 may include a photoluminescent material. In this regard, with the button cap 130 being formed from a translucent material, the photoluminescent material may “charge” during the day or in brighter areas, and may illuminate at night or in darker areas. In an example embodiment, some translucent materials may allow more light to pass through than others. For instance, clear acrylic may be more efficient for allowing the graphic 210 comprising the photoluminescent material to charge than clear propylene, for example. This may be because clear propylene may only pass blue light through, which may greatly reduce the efficiency of charging the photoluminescent material. In an example embodiment, the button cap 130 itself may be molded in the photoluminescent material. In this regard, the button cap 130 may charge up during the day or in brighter areas, and may illuminate at night or in darker areas. In some cases, the photoluminescent material may be a long-persistent phosphor material. The long-persistent phosphor may be included in either the graphic 210 or the button cap 130 itself. In an example embodiment, the button cap 130 may be molded from the translucent material while the second set of retention tabs 150 may still be dual shot molded for the increased resistance to material fatigue. In some other cases, the graphic 210 may be dual shot molded into the recessed portion 128 of the wheel cover 120 in a different color material so that the graphic 210 may be visible in the customization cavity 200.

FIG. 11 also shows the operable coupling of the first set of retention tabs 140 to the lip 112 of the wheel 110. In FIG. 11, the section through the wheel 110 is shown by the darkest shading, the section through the wheel cover 120 is shown by the medium shading, and the section through the button cap 130 is shown by the lightest shading. In this regard, as the wheel cover 120 may be inserted onto the wheel 110, the first set of retention tabs 140 may engage the lip 112. The first tabs 144 may extend beyond the lip 112 such that the first projection 148 may slide by the lip 112 as the wheel cover 120 is inserted. Responsive to the wheel cover 120 being inserted onto the wheel 110, the first projection 148 and the first set of spacer members 170 may engage the lip 112, due to being biased by the wire ring 142, such that the lip 112 may be disposed between the first projection 148 and the first set of spacer members 170 at each first tab 144. Thus, while the wheel cover 120 is operably coupled to the wheel 110, the first set of spacer members 170 may define the first standoff height (H1) between the wheel cover 120 and the wheel 110. Simultaneously, the button cap 130 may be operably coupled to the wheel cover 120 via the second set of retention tabs 150 and the set of retention slots 180. The second set of spacer members 190 disposed at the button cap 130 may define the second standoff height (H2) of the customization cavity 200 by contacting an edge of the recessed portion 128. As shown in FIG. 11, the diameter of the circle pattern of the first set of retention tabs 140, the second set of retention tabs 150, and the set of retention slots 180 may all be the same. This may allow the button cap 130 to be installed on the wheel 110 alone (without the wheel cover 120) or onto the wheel cover 120, interchangeably.

FIG. 12 shows an alternate section view with the wheel 110 removed for added visibility. In FIG. 12, the darkest shading represents the section through the wheel cover 120 while the lighter shading represents the section through the button cap 130. The view of FIG. 12 may better show the second set of retention tabs 150 extending through the set of retention slots 180, as well as the customization cavity 200.

FIGS. 13 and 14 depict the button cap 130 operably coupled to the wheel 110 without the wheel cover 120. As described above, because the first standoff height (H1) may be equal to the second standoff height (H2), and because the diameter of the circle pattern of the first set of retention tabs 140, the second set of retention tabs 150, and the set of retention slots 180 may all be the same, the button cap 130 may be alternatingly, and interchangeably, operably coupled to the wheel cover 120 and to the naked wheel 110. In the example embodiment shown in FIG. 13, the second set of spacer members 190 may contact the lip 112 to define the second standoff distance (H2) of the button cap 130 while the second set of retention tabs 150 engage the lip 112. This may reduce the likelihood of the button cap 130 rattling in either the wheel 110 or the wheel cover 120 by not having the button cap 130 extend to an incorrect depth.

A wheel cover for a wheel of a vehicle of an example embodiment may therefore be provided. The wheel cover may include a cover portion removably operably coupleable to the wheel via a first set of retention tabs, the cover portion may be centered at an axis of rotation of the wheel and may cover spokes of the wheel, and a button cap removably operably coupleable to the wheel cover via a second set of retention tabs, the button cap may be centered at the axis of rotation of the wheel. The first set of retention tabs may be urged by a wire ring into engagement with a lip of the wheel, the lip may extend around the axis of rotation at a center bore of the wheel. The second set of retention tabs may insert into corresponding ones of a set of retention slots disposed in the cover portion.

The wheel cover of some embodiments may include additional features, modifications, augmentations and/or the like to achieve further objectives or enhance performance of the wheel cover. The additional features, modifications, augmentations and/or the like may be added in any combination with each other. Below is a list of various additional features, modifications, and augmentations that can each be added individually or in any combination with each other. For example, the button cap may be alternately operably coupleable to the cover portion itself and to the wheel without the wheel cover. In an example embodiment, individual ones of the set of retention slots may be disposed between consecutive ones of the first set of retention tabs. In some cases, the wheel cover may include a first set of spacer members that may define a first standoff height between the wheel cover and the wheel. In an example embodiment, the first set of spacer members may be disposed at the first set of retention tabs. In some cases, the button cap may include a second set of spacer members that may define a second standoff height between the button cap and the cover portion. In an example embodiment, individual ones of the second set of spacer members may be disposed between consecutive ones of the second set of retention tabs. In some cases, the first standoff height may be equal to the second standoff height. In an example embodiment, the second standoff height may define a customization cavity that may be disposed between the button cap and the wheel cover, the customization cavity may be customizable with a graphic. In some cases, the button cap may be formed from a translucent material that may permit light to pass through the button cap and onto the graphic. In an example embodiment, the graphic may include a photoluminescent material disposed at the wheel cover beneath the button cap. In some cases, the second set of retention tabs maybe dual shot molded to increase longevity and fatigue resistance. In an example embodiment, the wire ring may be disposed on a radially interior side of the first set of retention tabs and may urge the first set of retention tabs radially outward toward the lip.

A wheel assembly for a vehicle may therefore be provided. The wheel assembly may include a wheel which may be operably coupled to the vehicle, the wheel may include a lip that may extend around an axis of rotation at a center bore of the wheel, a wheel cover that may be removably operably coupleable to the lip via a first set of retention tabs, the wheel cover may be centered at the axis of rotation of the wheel to cover spokes of the wheel, and a button cap that may be removably operably coupleable to the wheel cover via a second set of retention tabs, the button cap may be centered at the axis of rotation of the wheel. The first set of retention tabs may be urged by a wire ring into engagement with the lip. The second set of retention tabs may insert into corresponding ones of a set of retention slots disposed in the wheel cover.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

What is claimed:

1. A wheel cover for a wheel of a vehicle, the wheel cover comprising:
a cover portion removably operably coupleable to the wheel via a first set of retention tabs, the cover portion being centered at an axis of rotation of the wheel to cover spokes of the wheel; and
a button cap removably operably coupleable to the wheel cover via a second set of retention tabs, the button cap being centered at the axis of rotation of the wheel,
wherein the first set of retention tabs is urged by a wire ring into engagement with a lip of the wheel, the lip extending around the axis of rotation at a center bore of the wheel, and
wherein the second set of retention tabs inserts into corresponding ones of a set of retention slots disposed in the cover portion.

2. The wheel cover of claim 1, wherein the button cap is alternately operably coupleable to the cover portion itself and to the wheel without the wheel cover.

3. The wheel cover of claim 1, wherein individual ones of the set of retention slots are disposed between consecutive ones of the first set of retention tabs.

4. The wheel cover of claim 1, wherein the wheel cover comprises a first set of spacer members that defines a first standoff height between the wheel cover and the wheel, and
wherein the first set of spacer members is disposed at the first set of retention tabs.

5. The wheel cover of claim 4, wherein the button cap comprises a second set of spacer members that defines a second standoff height between the button cap and the cover portion, and
wherein individual ones of the second set of spacer members are disposed between consecutive ones of the second set of retention tabs.

6. The wheel cover of claim 5, wherein the first standoff height is equal to the second standoff height.

7. The wheel cover of claim 5, wherein the second standoff height defines a customization cavity disposed between the button cap and the wheel cover, the customization cavity being customizable with a graphic.

8. The wheel cover of claim 7, wherein the button cap is formed from a translucent material to permit light to pass through the button cap and onto the graphic.

9. The wheel cover of claim 8, wherein the graphic comprises a photoluminescent material disposed at the wheel cover beneath the button cap.

10. The wheel cover of claim 1, wherein the second set of retention tabs are dual shot molded to increase longevity and fatigue resistance.

11. The wheel cover of claim 1, wherein the wire ring is disposed on a radially interior side of the first set of retention tabs to urge the first set of retention tabs radially outward toward the lip.

12. A wheel assembly for a vehicle, the wheel assembly comprising:
a wheel operably coupled to the vehicle, the wheel comprising a lip that extends around an axis of rotation at a center bore of the wheel,
a wheel cover removably operably coupleable to the lip via a first set of retention tabs, the wheel cover being centered at the axis of rotation of the wheel to cover spokes of the wheel; and
a button cap removably operably coupleable to the wheel cover via a second set of retention tabs, the button cap being centered at the axis of rotation of the wheel,
wherein the first set of retention tabs is urged by a wire ring into engagement with the lip, and
wherein the second set of retention tabs inserts into corresponding ones of a set of retention slots disposed in the wheel cover.

13. The wheel assembly of claim 12, wherein the button cap is alternately operably coupleable to the wheel without the wheel cover and to the wheel cover itself.

14. The wheel assembly of claim 12, wherein the wheel cover comprises a first set of spacer members that defines a first standoff height between the wheel cover and the wheel, and
wherein the first set of spacer members is disposed at the first set of retention tabs.

15. The wheel assembly of claim 14, wherein the button cap comprises a second set of spacer members that defines a second standoff height between the button cap and the wheel cover, and
wherein individual ones of the second set of spacer members are disposed between consecutive ones of the second set of retention tabs.

16. The wheel assembly of claim 15, wherein the first standoff height is equal to the second standoff height.

17. The wheel assembly of claim 15, wherein the second standoff height defines a customization cavity disposed between the button cap and the wheel cover, the customization cavity being customizable with a graphic.

18. The wheel assembly of claim 17, wherein the button cap is formed from a translucent material to permit light to pass through the button cap and onto the graphic.

19. The wheel assembly of claim 18, wherein the graphic comprises a photoluminescent material disposed at the wheel cover beneath the button cap.

20. The wheel assembly of claim 12, wherein the second set of retention tabs are dual shot molded to increase longevity and fatigue resistance.
